(19) United States
(12) Patent Application Publication
(10) Pub. No.: US 2026/0097766 A1
(43) Pub. Date: Apr. 9, 2026

(54) VEHICLE OPERATIONS WITH MAP OVERLAY ZONES

(71) Applicant: Ford Global Technologies, LLC, Dearborn, MI (US)

(72) Inventors: Parul Kothari, New Brunswick, NJ (US); Rose Ciriello, Pittsburgh, PA (US); Danielle Elchik, Pittsburgh, PA (US); Ghassan Atmeh, L'Anse, MI (US); Matthew Gilson, Pittsburgh, PA (US); Bradley Dryer, Pittsburgh, PA (US)

(73) Assignee: Ford Global Technologies, LLC, Dearborn, MI (US)

(21) Appl. No.: 18/907,934

(22) Filed: Oct. 7, 2024

(51) Int. Cl. B60W 30/14; B60W 10/18; B60W 10/20; B60W 60/00

(52) U.S. Cl. CPC B60W 30/146; B60W 10/20; B60W 60/001; B60W 10/18; B60W 2556/45; B60W 2756/10

(57) ABSTRACT

A vehicle computer can access a stored map. The map includes respective vehicle operating permissions for zones included in the map. A changed vehicle operating permission for one of the zones included in the map may be received. When the vehicle is within a specified distance of the one of the zones, the vehicle is operated according to the changed operating permission. The changed vehicle operating permission can downgrade autonomous control of vehicle speed and/or steering.

### BACKGROUND

Various vehicle features may utilize map data. For example, a vector map or maps may be provided in a vehicle. A vector map utilizes vector graphics techniques to store and render map data. To specify geographic locations, a vector map can utilize a geographic coordinate system in which coordinates are defined by positive and/or negative values for latitude and longitude. Further, a vector map can provide different types or layers of data, such as data describing roads, railroad paths, features of utility networks, drainage features, airports, elevation contours, coastlines, jurisdictional boundaries, descriptions of populated places such as cities, states, provinces, countries, etc., and/or an index to geographic names associated with locations.

### BRIEF DESCRIPTION OF THE DRAWINGS

FIG. 1 is a diagram of an example vehicle system.

FIG. 2 is a diagram illustrating an example roadway including a zone thereof.

FIG. 3 is a flowchart illustrating an example process for generating a map overlay zone.

FIG. 4 is a diagram of an example process for operating a vehicle based on map overlay zones.

### DETAILED DESCRIPTION

The present disclosure includes techniques to support vehicle operation under dynamically changing roadway and/or travel conditions. Changed operating permissions for zones or areas of a roadway can be dynamically provided as described herein.

A system comprises a processor and a memory that may be included in a vehicle computer. The memory stored instructions executable by the processor to access a map stored in a vehicle, wherein the map includes respective vehicle operating permissions for zones included in the map; receive, in the vehicle, a changed vehicle operating permission for one of the zones included in the map; and when the vehicle is within a specified distance of the one of the zones, operate the vehicle according to the changed operating permission; wherein the changed vehicle operating permission downgrades autonomous control of vehicle speed and/or steering.

The changed vehicle operating permission may be a changed speed limit. The vehicle may be operated the vehicle according to the changed speed limit. The changed vehicle operating permission may be cruise control, hands-on operation, or hands-free operation. The one of the zones may be defined by a start boundary and an end boundary of a lane of a roadway. The changed vehicle operating permission for the one of the zones may be received in the vehicle during an over-the-air update provided upon vehicle startup. The changed vehicle operating permission for the one of the zones may be received in the vehicle while the vehicle is moving. The changed vehicle operating permission for the one of the zones may be received in the vehicle while the vehicle is operating according to the respective vehicle operating permission for the one of the zones.

The changed vehicle operating permission for the one of the zones may include a specified time of expiration after which the vehicle is not operated in the one of the zones according to the changed vehicle operating permission. The changed vehicle operating permission for the one of the zones may include a specified time window, whereby adjustment of the operation is made during the specified time window and is not made outside of the specified time window.

The instructions may further include instructions to receive a further changed vehicle operating permission for the one of the zones; and make a further adjustment to the operation of the vehicle according to the further changed vehicle operating permission for the one of the zones.

The instructions may further include instructions to receive, in the vehicle, a second changed vehicle operating permission for a second one of the zones; determine that one of the zones and the second one of the zones overlap; and operate the vehicle according to the changed vehicle operating permission for the second changed vehicle operating permission according to a precedence between the one of the zones and the second one of the zones.

The map may be a vector map and the zones may be defined according zones associated with tiles of the vector map, and the vehicle operating permissions may be included in data for respective ones of the tiles.

The changed vehicle operating permission may be generated according to programming in a server computer to indicate the changed vehicle operating permission based on data aggregated from a plurality of second vehicles exceeding a threshold.

A method comprises accessing a map stored in a vehicle, wherein the map includes respective vehicle operating permissions for zones included in the map; receiving, in the vehicle, a changed vehicle operating permission for one of the zones included in the map; and when the vehicle is within a specified distance of the one of the zones, operating the vehicle according to the changed operating permission; wherein the changed vehicle operating permission downgrades autonomous control of vehicle speed and/or steering.

The changed vehicle operating permission may be a changed speed limit. The vehicle may be operated the vehicle according to the changed speed limit. The changed vehicle operating permission may be cruise control, hands-on operation, or hands-free operation. The one of the zones may be defined by a start boundary and an end boundary of a lane of a roadway. The changed vehicle operating permission for the one of the zones may be received in the vehicle during an over-the-air update provided upon vehicle startup. The changed vehicle operating permission for the one of the zones may be received in the vehicle while the vehicle is moving. The changed vehicle operating permission for the one of the zones may be received in the vehicle while the vehicle is operating according to the respective vehicle operating permission for the one of the zones.

The changed vehicle operating permission for the one of the zones may include a specified time of expiration after which the vehicle is not operated in the one of the zones according to the changed vehicle operating permission. The changed vehicle operating permission for the one of the zones may include a specified time window, whereby adjustment of the operation is made during the specified time window and is not made outside of the specified time window.

The method may further comprise receiving a further changed vehicle operating permission for the zone; and making a further adjustment to the operation of the vehicle according to the further changed vehicle operating permission for the one of the zones.

The method may further comprise receiving, in the vehicle, a second changed vehicle operating permission for a second one of the zones; determining that the one of the zones and the second one of the zones overlap; and operating the vehicle according to the changed vehicle operating permission for the second changed vehicle operating permission according to a precedence between the one of the zones and the second one of the zones.

The may be generated according to programming in a server computer to indicate the changed vehicle operating permission based on data aggregated from a plurality of second vehicles exceeding a threshold.

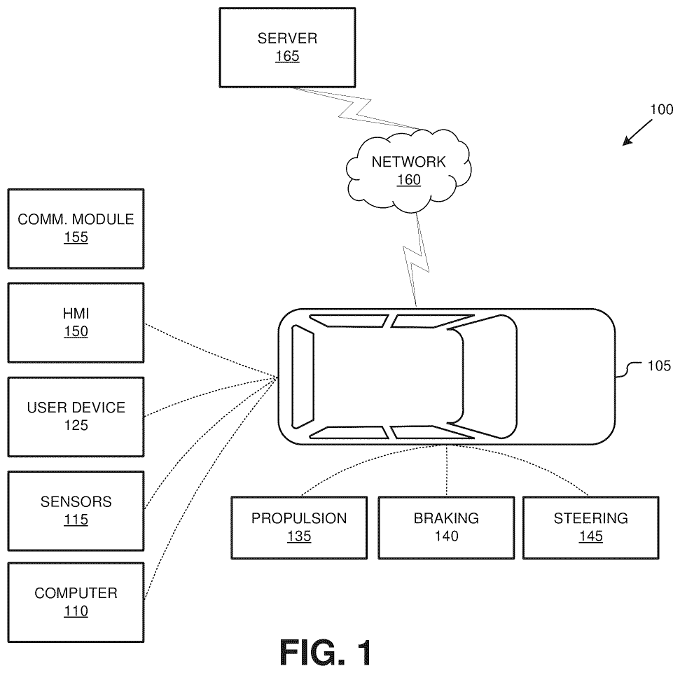

FIG. 1 illustrates an example system 100 for a vehicle 105. A computer 110 in the vehicle 105 is programmed to receive data collected from one or more sensors 115, and other sensors (not shown), to provide certain vehicle data. For example, one or more camera sensors 115 may provide image data from a camera's field of view. A user device with a touch screen may be disposed in vehicle 105. Example user devices include a vehicle computer 110 communicatively coupled (e.g., via a vehicle network) to an HMI 150 with a touch screen installed as part of a vehicle 105 infotainment system, or a hand-held portable computing device 125 with a touch screen. While all modern original equipment manufacturers (OEMs) of passenger vehicles currently warn drivers against using a hand held portable device while driving a vehicle due to safety concerns, it is anticipated that technology and the regulatory framework may evolve in the future to where such an activity becomes safe and permissible.

Vehicle data may further include a location of the vehicle 105, data about an environment around a vehicle, data about an object outside the vehicle such as another vehicle, etc. A vehicle location may be provided in a conventional form, e.g., geo-coordinates such as latitude and longitude coordinates obtained via a navigation system that uses a global navigation satellite system (GNSS) such as the Global Positioning System (GPS) system. Further examples of vehicle data can include measurements of vehicle systems and components, e.g., a vehicle speed or velocity, a level of fuel in a fuel tank, etc.

A computer 110 can be provided to control one or more vehicle operations including steering, acceleration or speed control, and/or braking. Accordingly, system 100 is shown comprising vehicle 105 which may include Driver Assistance System (DAS) features. A computer 110 (e.g., one or more vehicle 105 electronic control units, i.e., ECUs) can be configured to operate the vehicle 105 independently of operation by an occupant with regard to certain features. A computer 110 may be programmed to provide a driver assistance system (DAS) such as cruise control (where the computer maintains vehicle speed according to a set speed), adaptive cruise control (ACC) (where the computer maintains the vehicle speed according to a set speed but can adjust vehicle speed based on detected distances and/or speeds of other vehicles), and/or hands-free driving. For example, the computer 110 could provide hand-free driving in combination with ACC such that the computer 110 controls steering, braking and acceleration. In another example, the computer 110 could provide ACC and require hands-on operation. The computer 110 may be programmed to operate a propulsion system 135, a braking system 140, a steering system 145, a device screen that displays a Human Machine Interface (HMI) 150, and/or other vehicle systems.

A computer 110 is generally programmed for communications on a vehicle network (not shown), for example, a conventional vehicle communications bus such as a Controller Area Network (CAN) bus, a Local Interconnect Network (LIN) bus, etc., and/or other wired and/or wireless technologies, e.g., Bluetooth®, Wi-Fi®, Ethernet, etc. Via the network, bus, and/or other wired or wireless mechanisms (e.g., a wired or wireless local area network in the vehicle 105), the computer 110 may transmit messages to various devices in the vehicle 105 and/or receive messages from the various devices, e.g., sensors 115, controllers and actuators (not shown), etc.

Alternatively or additionally, for example, in cases where the computer 110 actually comprises multiple devices, the vehicle network may be used for communications between devices represented as the computer 110 in this disclosure. For example, the computer 110 can be a generic computer with a processor and memory as described above, and/or may include a dedicated electronic circuit including an application specific integrated circuit (ASIC) that is manufactured for a particular operation, e.g., an ASIC for processing sensor data and/or communicating the sensor data. In another example, the computer 110 may include a Field-Programmable Gate Array (FPGA), which is an integrated circuit manufactured to be configurable by a user. Typically, a hardware description language such as Very high speed integrated circuit Hardware Description Language (VHDL) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the computer 110 may be programmed for communicating with a network and/or devices outside of the vehicle (not shown), which may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 115. The memory can be a separate device from the computer 110, and the computer 110 can retrieve data stored in the memory via a network in the vehicle 105, e.g., over a CAN bus, a wireless network, etc. Alternatively or additionally, the memory can be part of the computer 110, e.g., as a memory of the computer 110.

Sensors 115 can include a variety of devices. For example, various controllers in a vehicle 105 may operate as sensors 115 to provide data via the vehicle network or bus, e.g., data relating to vehicle speed, acceleration, location, subsystem and/or component status, etc. Further, other sensors 115 could include cameras, motion detectors, etc., i.e., sensors 115 may provide data for evaluating a status of a component, evaluating a slope of a roadway, etc. The sensors 115 could, without limitation, also include short range radar, long range radar, light detection and ranging (LIDAR), ultrasonic transducers, and the like. Cameras herein typically are optical cameras, e.g., in the visible spectrum, but could alternatively or additionally include other kinds of cameras, e.g., time-of-flight, infrared, etc.

Collected data can include a variety of data collected in a vehicle 105. Examples of collected data are provided above. Data are generally collected using one or more sensors 115, and may additionally include data calculated therefrom in the computer 110. In general, collected data may include any data gathered by the sensors 115 and/or computed from such data.

The vehicle 105 can include a plurality of vehicle components. In this context, a vehicle component may include one or more hardware components adapted to perform a mechanical function or operation—such as moving the vehicle 105, slowing or stopping the vehicle 105, steering the vehicle 105, etc. Non-limiting examples of components include a propulsion component 135 (that includes, e.g., an internal combustion engine and/or electric motor, etc.), a transmission component, a steering assembly (e.g., that may include one or more of a steering wheel, a steering rack, etc.), a brake component 140, a park assist component, an adaptive cruise control component, an adaptive steering component 145, a movable seat, and the like. Components can include computing devices, e.g., electronic control units (ECUs) or the like and/or computing devices such as described above with respect to the computer 110, and that likewise communicate via a vehicle network.

The HMI 150 typically includes one or more of a display, a touchscreen display, a microphone, a speaker, etc. The user can provide input to devices such as the computer 110 via the HMI 150. The HMI 150 can communicate with the computer 110 via the vehicle network, e.g., the HMI 150 can send a message including the user input provided via a touchscreen, microphone, a camera that captures a gesture, etc., to a computer 110, and/or can display output, e.g., via a screen, speaker, etc.

In addition, the vehicle computer 110 may be configured for communicating via a vehicle-to-vehicle communication module 155 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer 165 (typically via direct radio frequency communications)). The communications module 155 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 155 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 155 according to any suitable short-range communications mechanism (e.g., DSRC, cellular, or the like).

The network 160 represents one or more mechanisms by which a vehicle computer 110 may communicate with remote computing devices (e.g., the remote server computer 165, another vehicle computer, the infrastructure element 140, etc.). Accordingly, the network 160 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

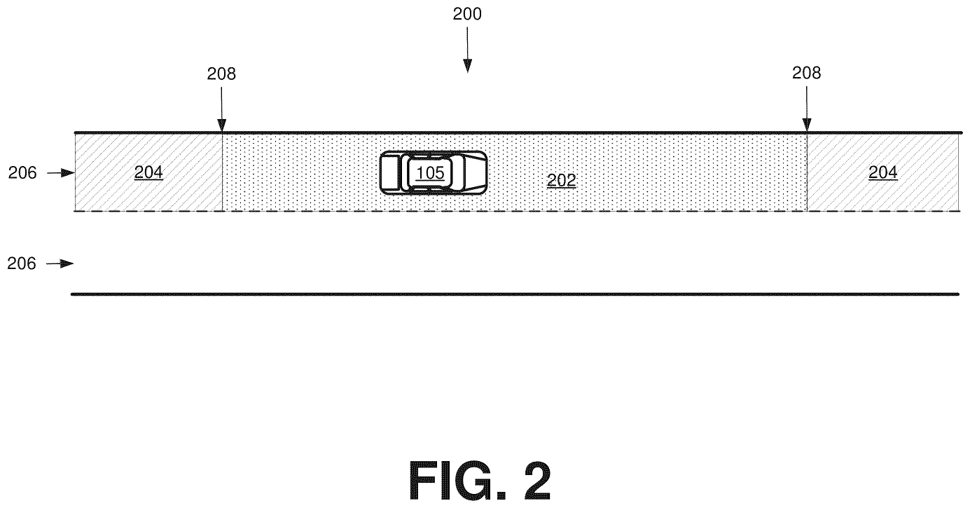

Turning out to FIG. 2, a map can include features of a roadway 200 such as an interstate highway, a divided highway, a city street, etc. The roadway 200 can include multiple lanes 206 for travel by vehicles including a vehicle 105. In the illustrated example, the roadway 200 includes two lanes 206 of travel in a same direction. The map can include one or more zones 202. A zone 202 can specify a portion or segment of the roadway 200. The map could include data specifying zones 202, and/or a zone 202 could be specified based on data in a map overlay zone (described below) that includes boundaries 208 for zones 202, that can then be located on the map according to geo-coordinates for the boundaries 208.

The illustrated example zone 202 is specified for a single lane 206 of the roadway 200. Further, one or more buffers 204 can be defined with respect to a zone 202. A buffer 204 can be used to specify a distance from a zone 202 at which the computer 110 should implement an operating permission (explained below) for the zone 202. However, buffers 204 could be omitted for some or all zones 202 included in a map, i.e., the specified distance for implementing or changing operating permission for a zone 202 could be zero or, put another way, the specified distance from a zone 202 could be simply a boundary 208 of the zone 202. A boundary 208 could be defined according to a line or a point on a map, e.g., a point specified by a geo-coordinate or a line specified by a set of geo-coordinates.

A vehicle computer 110 includes, and/or is able to access via the vehicle network, the map that includes respective vehicle operating permissions for zones 202 included in the map. The map includes a set of digital data specifying locations, typically according to geo-coordinates, for various features such as roadways 200, buildings, points of interest, etc. The map typically is a vector map with various layers of data describing such various features. A “zone” herein refers to a geographic area such as may be defined according to geo-coordinates, a geo-fence, or the like. For example, a map zone 202 could be defined for a segment of a roadway 200 (e.g., a highway or city street) according to a starting boundary 208 and an ending boundary of the roadway segment. An “operating permission” herein means a datum or data specifying an operation that a vehicle may perform. For example, an operation may be moving or operating a vehicle 105 according to a specified speed limit, operating a vehicle 105 with control of vehicle speed by a computer 110 (e.g., according to an adaptive cruise control feature), or operating a vehicle 105 with control of vehicle steering by computer 110 (e.g., according to hands-free operation, automatic lane change, a self-driving feature, etc.).

A set of one or more operating permissions can be provided for a zone included in a map. Operating permissions may be determined or defined based on other map features. For example, and operating permission such as speed limit and/or a permission permitting or forbidding hands-free operation and/or requiring hands-on operation could be specified for a map zone where map data indicates that construction or roadwork is occurring. Further, updates or changes in operating permission or permissions for a zone can be provided to a vehicle via the network 160, e.g., via what may be referred to as an over-the-air (OTA) update.

An updated operating permission can be provided included in what is referred to herein as a “map overlay zone.” A “map overlay zone” (or “MOZ”) is a datum or data that supplements, i.e., adds to and/or modifies, data in an existing map such as a map previously stored in a vehicle 105 and accessed by a vehicle computer 110. As mentioned above, a vehicle map can be a vector map. In such a case, a map overlay zone may be provided to modify or amend map data for a map zone, e.g., a roadway segment. A computer 110 in a vehicle 105 can thus receive a map overlay zone, thereby receiving a changed vehicle operating permission for a zone included in an existing map stored in the vehicle 105. In one example, a map overlay zone is defined according to, i.e., is provided as data associated with, a tile of a vector map and the vehicle 105 operating permission is included in data for the tile that can then be used to augment the map as previously or currently stored in the vehicle 105.

Table 1 below lists example types of map overlay zones and their respective operating permissions in an example implementation.

TABLE 1

| MOZ | Operating Permissions |
|---|---|
| Adaptive cruise control | Adaptive cruise control (i.e., a computer 110 controls of vehicle 105 speed |
| | and following distance of a forward vehicle) is permitted but other |
| | autonomous operations, including eyes free and hands-free driving, are not |
| | permitted. |
| Hands-free zone | Hands-free driving is permitted but eyes-free driving is disabled. |
| Speed adjustment zone | Provides a changed speed limit for a map zone 202 that typically adjusts or |
| | deviates from a default or stored map speed limit. |

As mentioned above, when a vehicle 105 is within a specified distance of a zone 202, that is, within a buffer area 204 or at a zone 202 boundary 208, the computer 110 can operate (or can instruct other vehicle 105 computers and/or components 135, 140, 145) to operate the vehicle according to the changed operating permission. For example, a map overlay zone could specify a changed speed limit for a zone 202, whereupon the computer 110 could provide output to a vehicle HMI 150 indicating the changed speed limit and/or could impose limitations on a speed at which the vehicle 105 can travel. In another example, a map overlay zone could specify a changed following distance for an adaptive cruise control, whereupon the computer 110 could provide output so that propulsion 135 and/or braking 140 are controlled to implement the changed following distance, i.e., so that the vehicle 105 follows a forward vehicle at a distance different than a previously-specified distance and any other specified factors, such as the vehicle speed. In yet another example, a changed vehicle operating permission could change permitted control of steering 145. For example, a map could specify for a zone 202 that hands-free driving along with automated lane change was permitted. A map overlay zone could specify for the zone 202 that only hands-free driving, but not automated lane change was permitted. In short, a changed vehicle operating permission may downgrade (but could alternatively or additionally upgrade) autonomous control, e.g., by computer 110, of vehicle speed and/or steering.

As mentioned above, an OTA including one or more map overlay zones could be provided from a server 165 upon vehicle 105 startup and/or could be triggered from a server 165 and provided in real-time or near real-time during vehicle 105 operation. Put another way, a changed or adjusted vehicle operating permission for the zone can be received in the vehicle during an over-the-air update provided upon vehicle startup, and/or an adjustment of a changed vehicle operating permission for the zone is received in the vehicle while the vehicle is moving.

For example, the server 165 could receive data for a zone 202 modifying a speed limit for the zone 202 and/or modifying other operating permissions such as a permission for hands-free operation and/or autonomous lane changes, and upon receiving this data could then provide an update to the vehicle 105. An OTA update could be based on a vehicle's geographic location. For example, on vehicle 105 startup, a computer 110 could cause the communication module 155 to transmit a location of the vehicle 105 via the network 160 to the server 165. The server 165 could then provide an OTA update, if any, of map overlay zones for zones 202 within a predetermined radius (e.g., 50 miles, 100 miles, 200 miles, etc.) of the vehicle 105. Alternatively or additionally, the server 165 could provide an OTA update via the network 160 upon receiving periodic or real time updates from the vehicle 105 specifying a current location of the vehicle 105, and determining that an update was available for a zone 202 within a predetermined radius (which could be different than the predetermined radius applicable upon vehicle 105 startup) of the vehicle 105 (e.g., 5 miles, 20 miles, 50 miles, etc.).

In one example, a map overlay zone including an adjustment of a vehicle operating permission for a zone 202 is received in the vehicle 105 while the vehicle 105 is operating according to the respective vehicle operating permission for the zone 202. For example, the vehicle 105 could be operating according to a hands-free/autonomous lane change permission, and a map overlay zone could specify to adjust that permission to merely a hands-free permission as the vehicle 105 is approaching the zone 202 (e.g. is in a buffer 204 of the zone 202) or is in the zone 202.

Further, a vehicle 105 can receive multiple OTA updates. For example, the vehicle 105 could receive a first OTA update on vehicle 105 startup, and then a second OTA update while the vehicle is operating, e.g., moving along a roadway 200. Alternatively or additionally, the vehicle 105 could receive first and second OTA updates while the vehicle is operating. First and second OTA updates could include first and second changed operating permissions for a same zone 202. For example, a first OTA update could specify a changed vehicle operating permission for a zone 202 on vehicle 105 startup, and then during vehicle 105 operation the computer 110 could receive a second or further changed vehicle operating permission for the zone 202. The vehicle 105 on receiving a second changed operating permission for a zone 202 could then make the further adjustment to the operation of the vehicle 105 according to the further changed vehicle operating permission for the zone. For example, a map stored in a vehicle 105 could specify for a zone 202 that the zone permitted hands-free operation and autonomous lane changes. A first adjustment could specify for the zone 202 that only hands-free operation (but not autonomous lane changes) were permitted, and then a second or further adjustment could specify for the zone 202 that hands-free operation is not permitted.

A map overlay zone could include a time parameter such as an expiration date and/or time for a changed vehicle operating permission. Put another way, a map overlay zone specifying a changed vehicle operating permission for zone 202 could include includes a specified time of expiration after which the vehicle 105 is not operated in the zone 202 according to a changed vehicle operating permission in the map overlay zone. In another example, a map overlay zone could include a date and/or time range or window during which the changed vehicle operating permission is applicable for a zone 202. The system of claim 1, wherein the changed vehicle operating permission for the zone includes a specified time window, whereby the adjustment of the operation is made during the specified time window and is not made outside of the specified time window.

In some examples, a map stored in and/or accessible by a computer 110 could describe overlapping zones 202. That is, an ending boundary 208 for a first zone 202 could be beyond a starting boundary 208 for a second zone 202 in a direction of travel on a roadway 200. Put another way, there could be an area of a roadway 200 in both of the first and second zones 202. When the vehicle 105 is traveling in a first zone 202 that overlaps with a second zone 202, the computer 110 in the vehicle 105 could be causing the vehicle 105 to operate according to a first changed vehicle operating permission for the first zone 202. When the computer 110 receives receive a second changed vehicle operating permission for a second a zone, computer 110 could determine whether the first and second zones 202 overlap, i.e., have an area of the roadway 200 in common. Upon determining that the first and second zones 202 overlap, the computer 110 could then operate the vehicle 105 according to the changed vehicle operating permission for the second changed vehicle operating permission according to a precedence between the zone and the second a zone. Table 2 provides an example of precedences or priorities between different types or categories of map overlay zones in the implementation for which Table 1 above was provided.

TABLE 2

| MOZ | Precedence Rule |
|---|---|
| Adaptive cruise control | Always has top precedence. |
| Hands-free zone | If overlapping with the speed adjustment zone then both the hands-free |
| | zone and the speed adjustment zone can be implemented (i.e., |
| | downgrade from an automated lane change mode if active, and also |
| | adjust speed according to the speed adjustment zone), but cedes |
| | precedence to adaptive cruise control only zone. |
| Speed adjustment zone | If overlapping with the hands-free zone then both the hands-free zone |
| | and the speed adjustment zone can be implemented (i.e., downgrade |
| | from an automated lane change mode if active, and also adjust speed |
| | according to the speed adjustment zone), but cedes precedence to |
| | adaptive cruise control only zone. |

Map overlay zones can be determined in a server 165. Programming in the server 165 could specify to compare received data to predetermined thresholds and/or criteria to determine a map overlay zone. The received data could be provided by test vehicles driven on a roadway 200 and/or user vehicles being driven on a roadway 200 (e.g., crowd sourced). The server 165 could be programmed to determine incidents warranting a map overlay zone. The server 165 could generate a map overlay zone according to user input based on a user evaluating thresholds or criteria for incidents. An incident herein means a feature or event of a roadway for which a threshold and/or criterion is stored in the server 165 to determine map overlay zones. Incidents may be reported according to locations that may be defined according to geo-coordinates. Nonlimiting examples of incidents are:
construction object or objects (e.g., cones, signs, etc.) detected;
lane boundary deviation detected (e.g., a “lane shift” due to construction and/or changed roadway 200 configuration);
road surface deviation detected; and/or
speed limit deviation detected (e.g., detected speed limit is less than speed limit indicated on map).

Table 3 below provides an example of criteria for determining to generate or remove a map overlay zone based on incident reports at a location; for example, data from vehicles passing through a zone could be aggregated and aggregated data compared to thresholds; if a threshold is met or exceeded, an MOZ could be generated . . .

TABLE 3

| MOZ Permissions | Generation Criteria | Removal Criteria |
|---|---|---|
| Adaptive cruise | 60% of vehicles passing a location | 80% of vehicles passing the location |
| control only | provide positive detections of | with negative incident detections (e.g., |
| | incidents (e.g., construction objects), | the reverse or opposite of the incidents |
| | with a minimum of 5 vehicles in 24 | generating the MOZ, e.g., no |
| | hours reporting detections, with at | construction objects), with a minimum |
| | least two detections spaced apart by | of 5 vehicles in 24 hours reporting |
| | at least 30 minutes. | detections, with at least two detections |
| | | spaced apart by at least 30 minutes. |
| Hands-free zone | 60% of vehicles passing a location | 80% of vehicles passing the location |
| | provide positive detections of | with negative incident detections (e.g., |
| | incidents (e.g., lane boundary | the reverse or opposite of the incidents |
| | deviation), with a minimum of 5 | generating the MOZ, e.g., no lane |
| | vehicles in 24 hours reporting | boundary deviation), with a minimum |
| | detections, with at least two | of 5 vehicles in 24 hours reporting |
| | detections spaced apart by at least 30 | detections, with at least two detections |
| | minutes. | spaced apart by at least 30 minutes. |
| Speed adjustment | 60% of vehicles passing a location | 80% of vehicles passing the location |
| zone | provide positive detections of | with negative incident detections (e.g., |
| | incidents (e.g., speed limit sign), with | (e.g., speed limit sign), with a minimum |
| | a minimum of 5 vehicles in 24 hours | of 5 vehicles in 24 hours reporting |
| | reporting detections, with at least two | detections, with at least two detections |
| | detections spaced apart by at least 30 | spaced apart by at least 30 minutes. |
| | minutes. | |

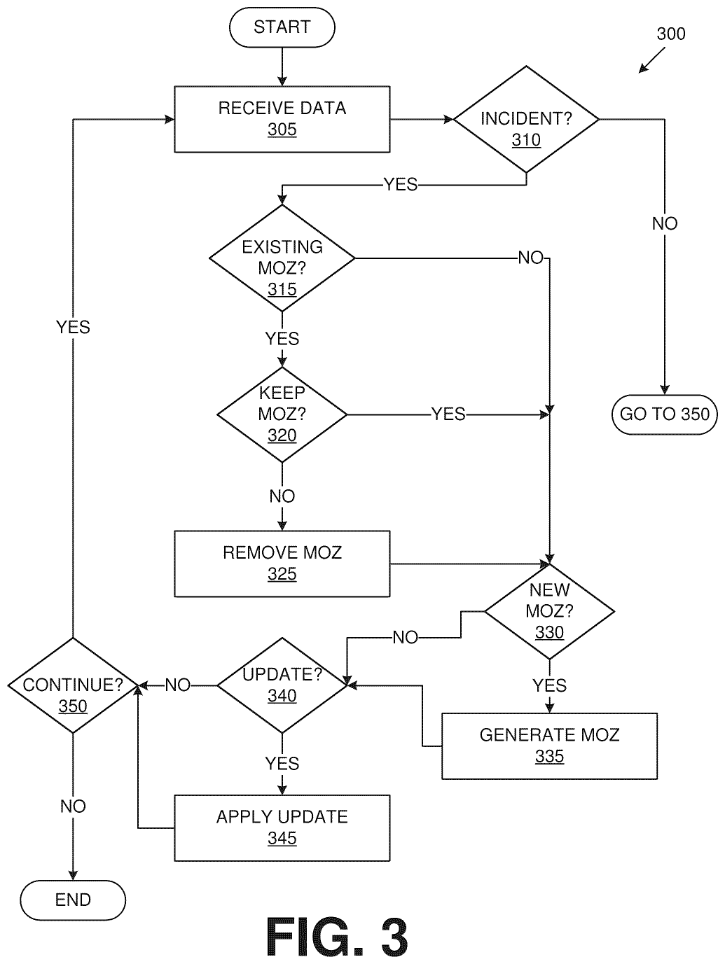

FIG. 3 is a flowchart illustrating an example process 300 for generating a map overlay zone. The various described process blocks could be executed in a different order then presented herein, and/or certain blocks could be omitted and/or other blocks could be added. A server 165 can receive data to generate map overlay zones and/or map overlay zones can be provided to the server 165. The server 165 (which in this example may represent one or more different computing devices that may be at one or more different network locations) can provide map overlay zones to vehicles 105.

The process 300 may begin in a block 305, in which a server 165 receives data for a location on a map. The received data could be provided, in real-time or near real-time and/or as part of a manual upload or an upload provided on a periodic basis, by test vehicles driven on a roadway 200 and/or user vehicles being driven on a roadway 200 (e.g., crowd sourced). The data could describe a feature or event for the location which could be specified according to geo-coordinates or the like. The feature or event could describe a characteristic of the location such as a speed limit, a road surface, lane lines, construction objects, etc.

Following the block 305, in a block 310, the server 165 determines whether an incident is detected at the location of the feature or event identified in the block 305. An incident, as explained above, is a feature or event that meets or passes a predetermined threshold or criterion. If an incident is not detected, then the process 300 continues in a block 350. If an incident is detected, the process 300 continues at a block 315.

In the block 315, the server 165 determines whether an MOZ exists at the location of the feature or event identified in the block 305. Typically the server 165 stores a copy of a map deployed to one or more vehicles 105, or alternatively or additionally may store a subset or superset of a map deployed to one or more vehicles 105. In any event, a map or other data stored by the server 165 indicates locations, e.g., starting and ending boundaries 208, of zones 202 for which an MOZ is provided. If an MOZ exists at the location, then the process 300 proceeds to a block 320. Otherwise, the process 300 proceeds to a block 330.

In the block 320, the server 165 determines whether to keep or retain the MOZ. As explained above, the server 165 could store removal criteria for existing map overlay zones. Alternatively or additionally, a user could provide input to remove the map overlay zone based on a user's review of data relating to incidents identified at a location within the zone 202 for which the MOZ is provided. If is determined to keep the MOZ, then the process 300 proceeds to the block 330. Otherwise, the process 300 proceeds to a block 325.

In the block 325, the MOZ is removed from the map data stored by the server 165.

In the block 330, which may follow any of the blocks 315, 320, 325, the server 165 determines whether a new MOZ is to be defined or generated for the location identified as described above with respect to the block 305. If yes, the process 300 proceeds to a block 335. Otherwise, the process we hundred proceeds to a block 340.

In the block 335, the server 165 generates a new map overlay zone. Example criteria for MOZ generation are discussed above. Further, generation of an MOZ can include definition of the zone 202 to which the generated map overlay zone applies. For example, the server 165 could include programming to define start and end boundaries 208 a specified distance behind and ahead on a roadway 200 of a location of an incident. Further, the specified distance(s) from the incident could depend on a type of incident and/or could use feature or event data from multiple locations. For example, if the incident is a change in speed limit, the MOZ could have a start boundary 208 determined according to a location of signage indicating the changed speed limit, and an end boundary 208 likewise determined according to a location of signage indicating a further adjustment of the change speed limits or a reversion of the changed speed limit to a default speed limit. In another example, where an incident included detection of a construction object, the start and end boundaries 208 could be determined according to locations where a first construction object is detected and the last construction object is detected. Further, in these and other examples, sizes of buffers 204 could be determined according to a type of incident, e.g., a specified buffer 204 distance could be defined for a change in speed limit to give a vehicle 105 operator warning of an upcoming speed change; a specified buffer distance could similarly be specified for construction zones 202.

In a block 340, which may follow either of the blocks 330, 335, the server 165 determines whether a map overlay zone update is to be provided to vehicles 105. That is, if a map overlay zone was removed in the block 325 and/or a new map overlay zone was generated in the block 335, that the server 165 will determine to push or make available a map overlay zone update to vehicles 105. If an update is to be provided, then the process 340 proceeds to a block 345. Otherwise, the process 300 proceeds to a block 350.

In the block 345, the server 165 provides the update to vehicles 105. As explained above, the server 165 could make the update available via an OTA provided to a vehicle 105 on vehicle startup and/or in real time. Alternatively or additionally, the server 165 could make an update available for manual download.

In the block 350, which may follow either of the blocks 340, 345, it is determined whether the process 300 should continue. For example, the server 165 could periodically or continuously check to determine if new data is received as described above concerning the block 305. Alternatively, the process 300 could be manually initiated by a user providing input to the server 165 to process new data in the block 305. In any case, if the process 300 is to continue, that the block 305 is executed next. Otherwise, the process 300 ends following the block 350.

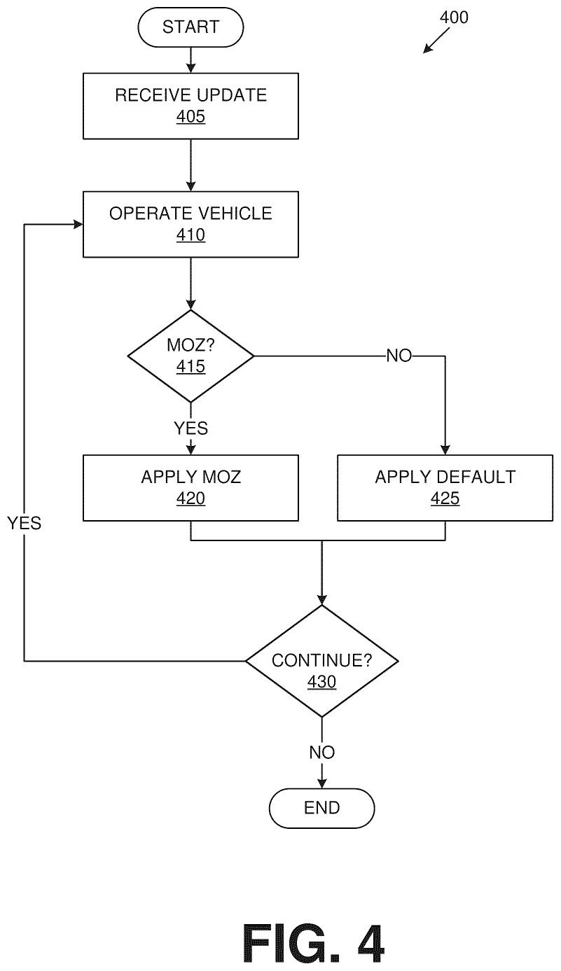

FIG. 4 is a diagram of an example process for operating a vehicle based on map overlay zones. The process 400 may be executed according to program instructions in a vehicle computer 110.

The process 400 may begin in a block 405, in which the vehicle computer 110 receives an update including a map overlay zone. As described above, the update may be provided on vehicle startup. Alternatively or additionally, although not illustrated in FIG. 4, an update could be provided in real-time or near real-time during vehicle 105 operation on a roadway 200. An update could include a new MOZ, modification of a prior MOZ, or removal of an MOZ. Further, the update may include one or more map overlay zones based on an area in which a vehicle 105 is located or currently operating. For example, a vehicle 105 could receive map overlay zones relating to zones 202 within a specified radius of the vehicle 105, e.g., 50 miles, 100 miles, 500 miles, etc.

Next, in a block 410, the vehicle 105 is operated on a roadway 200. Typically, operating the vehicle 105 can include operating the vehicle according to permissions included on a map stored in the vehicle. For example, permissions such as described above may specify for a zone 202 that the vehicle 105 is permitted to operate utilizing various features, such as adaptive cruise control, a hands-free mode, and eyes free mode, etc.

Next, in a decision block 415, as the vehicle 105 is operated on the roadway 200, the computer 110 determines whether the vehicle 105 is in or is approaching (e.g., is in a buffer 204 of) a zone 202 for which a map overlay zone has been updated or removed. If so, the process 400 proceeds to a block 420. Otherwise, the process 400 proceeds to a block 425.

In the block 420, computer 110 applies permissions specified in the MOZ for the current or upcoming zone 202, which as noted above could include downgrading or reducing permissions available in the zone 202 compared to default or standard permissions for the zone 202. For example, a zone 202 could ordinarily permit hands-free driving, but an MOZ could specify that only adaptive cruise control is allowed in the zone 202. Also, applying permissions specified in an MOZ could include removing an existing MOZ, that is, reverting to prior permissions upon removal of MOZ.

In the block 425, the computer 110 applies existing or default permissions, if any, specified for a current zone 202 (or a buffer 204 of an upcoming zone 202), that is, proceeds in the absence of a map overlay zone to be applied for the zone 202.

In a block 430, which may follow either of the blocks 420, 425, it is determined whether the process 400 is to continue. For example, a user could provide input to assume full manual control of a vehicle and exit the process 400, a vehicle could exit a roadway 200, park, be powered off, etc. If the process 400 is to continue, then then the vehicle operates according to output of either of the blocks 420, 425 and the process 400 returns to the block 410. Otherwise, the process 400 ends following the block 430.

Systems and methods described herein may be modified and/or omitted depending on the context, situation, and applicable laws, rules and regulations. Further, regardless actions that may be taken by a vehicle such as a computer controlling a vehicle, users should use good judgement and common sense when operating the vehicle. Operations described herein should always be implemented and/or performed in accordance with the owner manual and safety guidelines.

The computing devices discussed herein, including computer 110, include processors and memories. The memories generally including instructions executable by one or more of the computing devices' processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby causing one or more actions and/or processes to occur, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments and should in no way be construed so as to limit the disclosed subject matter.

“Based on” means based at least in part on unless explicitly stated otherwise. Therefore, if A is “based on” B, this means that A could be entirely determined based on B, or could be determined based on B and some other factor or factors.

Accordingly, it is to be understood that the present disclosure, including the above description and the accompanying Figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a processor and a memory, the memory storing instructions executable by the processor to:
access a map stored in a vehicle, wherein the map includes respective vehicle operating permissions for zones included in the map;
receive, in the vehicle, a changed vehicle operating permission for one of the zones included in the map; and
when the vehicle is within a specified distance of the one of the zones, operate the vehicle according to the changed operating permission;
wherein the changed vehicle operating permission downgrades autonomous control of vehicle speed and/or steering.

2. The system of claim 1, wherein the changed vehicle operating permission is a changed speed limit.

3. The system of claim 2, wherein the instructions further include instructions to operate the vehicle according to the changed speed limit.

4. The system of claim 1, wherein the changed vehicle operating permission is cruise control, hands-on operation, or hands-free operation.

5. The system of claim 1, wherein the one of the zones is defined by a start boundary and an end boundary of a lane of a roadway.

6. The system of claim 1, wherein the changed vehicle operating permission for the one of the zones is received in the vehicle during an over-the-air update provided upon vehicle startup.

7. The system of claim 1, wherein the changed vehicle operating permission for the one of the zones is received in the vehicle while the vehicle is moving.

8. The system of claim 1, wherein the changed vehicle operating permission for the one of the zones is received in the vehicle while the vehicle is operating according to the respective vehicle operating permission for the one of the zones.

9. The system of claim 1, wherein the changed vehicle operating permission for the one of the zones includes a specified time of expiration after which the vehicle is not operated in the one of the zones according to the changed vehicle operating permission.

10. The system of claim 1, wherein the changed vehicle operating permission for the one of the zones includes a specified time window, whereby adjustment of the operation is made during the specified time window and is not made outside of the specified time window.

11. The system of claim 1, wherein the instructions further include instructions to:
receive a further changed vehicle operating permission for the one of the zones; and
make a further adjustment to the operation of the vehicle according to the further changed vehicle operating permission for the one of the zones.

12. The system of claim 1, wherein the instructions further include instructions to:
receive, in the vehicle, a second changed vehicle operating permission for a second one of the zones;
determine that one of the zones and the second one of the zones overlap; and
operate the vehicle according to the changed vehicle operating permission for the second changed vehicle operating permission according to a precedence between the one of the zones and the second one of the zones.

13. The system of claim 1, wherein the map is a vector map and the zones are defined according zones associated with tiles of the vector map, and the vehicle operating permissions are included in data for respective ones of the tiles.

14. The system of claim 1, wherein the changed vehicle operating permission is generated according to programming in a server computer to indicate the changed vehicle operating permission based on data aggregated from a plurality of second vehicles exceeding a threshold.

15. A method, comprising:
accessing a map stored in a vehicle, wherein the map includes respective vehicle operating permissions for zones included in the map;
receiving, in the vehicle, a changed vehicle operating permission for one of the zones included in the map; and
when the vehicle is within a specified distance of the one of the zones, operating the vehicle according to the changed operating permission;
wherein the changed vehicle operating permission downgrades autonomous control of vehicle speed and/or steering.

16. The method of claim 15, wherein the changed vehicle operating permission is a changed speed limit, cruise control, hands-on operation, or hands-free operation.

17. The method of claim 15, wherein the changed vehicle operating permission for the one of the zones includes a specified time of expiration after which the vehicle is not operated in the one of the zones according to the changed vehicle operating permission and/or a specified time window, whereby adjustment of the operation is made during the specified time window and is not made outside of the specified time window.

18. The method of claim 15, further comprising:
receiving a further changed vehicle operating permission for the zone; and
making a further adjustment to the operation of the vehicle according to the further changed vehicle operating permission for the one of the zones.

19. The method of claim 15, further comprising:
receiving, in the vehicle, a second changed vehicle operating permission for a second one of the zones;
determining that the one of the zones and the second one of the zones overlap; and
operating the vehicle according to the changed vehicle operating permission for the second changed vehicle operating permission according to a precedence between the one of the zones and the second one of the zones.

20. The method of claim 15, wherein the changed vehicle operating permission is generated according to programming in a server computer to indicate the changed vehicle operating permission based on data aggregated from a plurality of second vehicles exceeding a threshold.
